(19) United States
(12) Patent Application Publication
(10) Pub. No.: US 2013/0161872 A1
(43) Pub. Date: Jun. 27, 2013

(54) Preservation of the Appearance of Pre-Printed Graphics on Hot Stretched Film

(71) Applicants: Brian Joseph Conrad, Appleton, WI (US); Gordon Charles Sarx, Kitchener (CA); Daniel Frank Janichek, Neenah, WI (US)

(72) Inventors: Brian Joseph Conrad, Appleton, WI (US); Gordon Charles Sarx, Kitchener (CA); Daniel Frank Janichek, Neenah, WI (US)

(73) Assignee: CURWOOD, INC, Neenah, WI (US)

(21) Appl. No.: 13/332,769

(22) Filed: Dec. 21, 2011

(51) Int. Cl. B29C 51/00

(52) U.S. Cl. 264/327

(57) ABSTRACT

The present disclosure is concerned with improving the appearance of graphics printed on a flexible polymer film which is subsequently heated to a forming temperature and then drawn into a mold to form a cavity adapted for the packaging of an item, typically a food item. The improvement is effected by reducing the heat transfer to the portions of the film carrying the graphics thereby reducing the formability of these portions so that they stretch less than the rest of the film which is drawn into the mold. Typically the film is heated by contact with a heated platen. In such cases the reduced heat transfer can be effected by having zones of a cooler temperature which are adapted to be in registry with the portions of the film carrying the graphics or by covering the portions of the heated platen in registry with these graphics with an insulating material such as Teflon tape. The mouth of the cavity can then be closed by sealing to another flexible polymeric film. If the films used are heat shrinkable, the sealed package can be subjected to thermal conditions which cause it to shrink about the packaged item.

### FIELD OF THE INVENTION

The present invention is concerned with preserving the appearance including both the opacity and clarity of graphics printed on packaging film which is stretched after the graphics are applied, in order to accommodate the item to be packaged. In those cases in which the film is subsequently shrunk, it is shrunk less than it was stretched to form fit the packaged item.

### BACKGROUND OF THE INVENTION

It has become a routine practice in food packaging to enclose food items, particularly meat and cheese, in a polymer film which can then sometimes be caused to shrink by the application of thermal energy so as to form fit the food item. One technique for enclosing the food item is to stretch a lower film to form a cavity into which the food item can be placed followed by sealing another film to the upper edges of the lower film to close the cavity into which the food item was placed. The lower film is typically rendered susceptible to stretching so as to form the food item receiving cavity by contact with a heated plate. The entire procedure of forming the cavity, placing the food item in the cavity, sealing a top film to the upper edges of the film forming the cavity and optionally causing both films to shrink to form fit the food item is described in U.S. Pat. No. 3,956,867 to Utz et al. of Multivac and U.S. Pat. No. 7,487,625 to Natterer et al. of Multivac, both incorporated by reference.

A concern has been the application of graphics such as labeling to the films in which the food items are packaged. It is not practical to apply the desired graphics to the film after the packaging operation and it is frequently not convenient to apply all of the desired graphics to the top film because of display considerations and because the surface area required for the graphics is too great to be conveniently accommodated by said top film. Among other things it is often desired to provide the graphics on portions of the package relatively distant or removed from the seam formed between the upper and lower films. This has resulted in graphics being applied to the lower film before it is stretched to form the food item receiving cavity. It is this subsequent stretching which causes a distortion of these graphics. Even when the stretched film has sometimes been shrunk, the enclosed food item did not permit the stretched film to shrink back to the unstretched dimensions it had when the graphics were applied. Thus even in this case the distortion is often not adequately ameliorated by this subsequent shrinking.

Historically attempts have been made to address this concern by covering a zone which spans the entire width or length of the heating plate with an insulating tape, such as a Teflon tape, such that this zone overlies the graphics to be preserved. However, this approach has resulted in the failure to form suitable packages depending upon the configuration of the cavity. In such cases, the reduction in the amount of film with unrestricted formability has resulted in excessive thinning and the resultant formation of holes in the formed film. Furthermore, the tape approach does not lend itself to creating zones of different thermal conduction. Thus a sharp line of demarcation is created between the insulated portion whose stretch is substantially restricted, and the balance of the film, which is undesirable, particularly from a structural point of view. This sharp line of demarcation is a zone of weakness which has been observed to cause a rupture in the film during the cavity forming operation.

### SUMMARY OF THE INVENTION

The present invention involves a process to form a cavity for the packaging of an item, preferably a food item, from a hot formable, optionally heat shrinkable film while preserving the readability and appearance of graphics printed on the formable film before stretching by selectively restricting the heat applied to the portion of the film carrying the graphics and thus that portion's ability to stretch, preferably by using a heating plate with zones heated to different temperatures. The zones are preferably configured such that the cooler zones are entirely within an interior margin extending in from the edges of the footprint of the heated plate used to render the film formable. It is also preferred that the cooler zones are configured to provide a stepped transition from the portion of the film carrying the graphics to the portion of the film heated to display the maximum stretch obtained in the cavity forming operation. It is particularly preferred that there be at least two cooler zones with the warmer one of the two entirely surrounding the perimeter of the one overlying the portion of the film carrying the graphics to be preserved.

It is advantageous to use multilayer films wherein the inner most layer is a readily heat sealable material such as polyethylene, there is a core layer with good barrier properties such as ethylene vinyl alcohol copolymer and the outer layer is a puncture and wear resistant material such as polyamide.

In one embodiment the selective restriction of the heat necessary to render the cavity forming film formable is part of a larger process in which a food item is placed in the cavity, a top film is sealed to the upper edges of the cavity forming lower film, preferably by heat sealing, and the sealed package so formed is subjected to sufficient heat to cause at least the lower film to shrink against the enclosed food item. In a preferred implementation of this embodiment, both the top sealing film and the bottom pouch forming film are heat shrinkable films formed by locking in shrinking stresses in their manufacture by a double bubble or tenter stretching process.

### BRIEF DESCRIPTION OF THE DRAWINGS

FIG. 1A is a top plan view of the mold used to form the cavity into which the item to be packaged is placed.

FIG. 1B is a cross section of the mold shown in FIG. 1A taken along line BB of FIG. 1A.

FIG. 1C is a cross section of the mold shown in FIG. 1A taken along line CC of FIG. 1A.

FIG. 2 is a top plan view of a portion of the film to be formed into the cavity into which the item to be packaged is placed showing the footprint of the heating plate, the outline of the graphics to be preserved and portions of the outline of the mold for forming the cavity.

FIG. 3 is an illustration of a test grid used to evaluate the stretch and distortion to which individual small portions of a film being formed into a cavity are subjected.

### DETAILED DESCRIPTION OF THE INVENTION

The present invention involves a modification to a well known process of packaging an item, particularly a food item, in a sealed flexible film container, by forming a cavity by hot forming a bottom portion of the packaging film followed by sealing it to a top portion, in which the bottom portion is rendered more amenable to carrying high quality graphics. This well known process involves rendering this bottom portion formable by heating it to an elevated temperature and subjecting it to substantial stretching to fill the cavity forming mold. It is sometimes inconvenient to apply graphics, such as labeling, to the packaged item, particularly when the packaged item does not exhibit any substantial flat surfaces. When the bottom portion is provided with graphics before it is hot formed to form the packaging cavity, the hot forming step of the process is modified to provide less heat to just the areas carrying the graphics causing them to stretch less and the graphics to distort less.

The inventive modification is effected by reducing the amount of heat transferred between a heated plate and just the lower film areas carrying the graphics. This is effected by either reducing the amount of heat transfer between the plate and these areas, for example by placing some insulating tape on the portions of the plate adapted to contact these areas, or by causing these portions of the plate to be cooler than other portions of this plate. It is preferred to cause the portion of the film carrying the graphics to have a temperature at least about 10° C. lower than the film immediately adjacent to this portion. These areas should be configured to leave a substantial margin between their outer edges and the footprint of this heating plate.

In the well known process, the film available to form the cavity is defined by the footprint of the heating plate. Only film which is brought to an elevated temperature by this plate is sufficiently formable to significantly contribute to the formation of this cavity. The film which forms this cavity is provided from roll stock which is advanced over the mouth of the mold which defines this cavity with its side edges being restrained from movement transverse to the film advancement direction, typically by clips or other mechanical holding devices. Thus the cavity is formed by stretching the film which has been brought to hot forming temperature by this heating plate resulting in a thinning of this portion of the film.

The approach of the present invention to preserving the quality of graphics applied to the film later used to form the cavity therefore involves reducing the formability of some of the film available for forming the cavity and therefore must be tailored to leaving adequate formability in the film available for stretching in both the transport or machine direction and the transverse direction so that the film does not become unduly thinned. This tailoring involves limiting the areas of cooler film and therefore reduced formability to approximately the area occupied by the graphics to be preserved and providing a substantial margin around these areas within the footprint of the heating plate. It is preferred that the margin in each direction amount to at least about 40%, preferably about 60% of the footprint of the heated plate in that direction available for a given mold cavity. In this regard, a single heating plate may serve to heat the film serving multiple mold cavities which are adjacent to each other. In such cases the available margin should be allocated on a proportional basis to the mold cavities. For instance, if two mold cavities which are side by side are served by a single heating plate, then the available margin in the transverse direction would be allocated between them such that each would be credited with one half of the margin lying between them.

In a particularly preferred embodiment, when the multiple separate graphics patterns are printed on a cavity forming film, each pattern is provided with its own thermal shielding. In other words, whatever mechanism is used to reduce the amount of heat transferred to the area carrying a given pattern is applied locally and specifically to just that area. If two areas are fairly close to one another but there is a gap between them, to the extent practical, the film in that gap should not be the target of reduced heat transfer.

The film used to form the cavity can be any film which has utility as a flexible packaging material, is rendered formable by the application of heat, is capable of being stretched to form a cavity and is capable of forming a reliable heat seal under reasonable conditions. It is preferred that the film be capable of a draw ratio of at least about 1.5 (i.e. that it be capable of being drawn into a die cavity such that the surface area which overlies the mouth of the die can be increased by at least about 50% upon being drawn into the die) and that it be rendered formable upon being exposed to temperatures between about 80 and 120° C. for between 1 and 2 seconds. The polymer films generally known to be suitable in the processes described in U.S. Pat. Nos. 3,956,867 and 7,487,652 are suitable. Optionally the films used are those known for the shrink packaging of food items such as those disclosed in US Published Patent Application 2008/0095960. These films typically have an outer layer which displays package integrity properties such as puncture resistance, scuff resistance and heat resistance, a core layer which displays barrier properties such as resistance to the transport of oxygen, and an inner layer which imparts heat sealability by having a fairly low temperature at which it fuses. Typical outer layers are polyamides and polyesters, typical core layers are ethylene vinyl alcohol copolymers (EVOH) and ployvinylidene chloride (PVDC), and typical inner layers are low melting point polyolefins such a low density polyethylenes (LDPE) and linear low density polyethylenes (LLDPE). These films are often carefully engineered to have a balance of properties and may have multiple additional layers. These additional properties may include shrinkability at elevated temperatures. This includes films which can be processed to retain shrinking stresses by a biaxial orientation treatment, typically as part of their manufacture, which are relieved by shrinking upon later exposure to an elevated temperature of around 80 to 120° C. In the application of this approach it is preferred to employ a film which displays a heat shrinkage of at least 30%, more preferably 40% at 90° C. in both the machine and transverse directions.

The film used to form the cavity should have sufficient thickness to allow for the thinning which occurs upon drawing it into the mold used to form the cavity and still provide for a finished package with an acceptable wall thickness, while also not being so thick as to impair its ability to be readily formed. The required thickness will, of course, depend upon the configuration of the cavity and the dimensions of the portion of the film available to form the cavity. Typically films with thicknesses between about 3 and 8 mils are suitable with films between about 4 and 6 mils being preferred. Commonly it is desired to have a finished package with a minimum wall thickness of greater than about 0.5 mils preferably greater than about 1 mil. In this regard, the thinnest wall thickness is typically seen in the “corners” of the package with the term “corners” being used in a broad sense because the cavities, which are designed to accommodate the items of a variety of shapes, are frequently not rectangular prisms.

The cavity into which the film is formed is designed to closely accommodate the item which is to be packaged in it. In those cases in which the film is caused to shrink after a package is formed by sealing another film across the mouth of the cavity, it is preferred that the shrink result in a reduction in size of no more than about 10%. In this regard, the cavity is typically formed by drawing the film vertically downward into the mold but is also formed with a horizontal lip surrounding the mouth of the cavity. After the item to be packaged is placed into the cavity, a portion of a flat compatible film is heat sealed to this horizontal lip and the sealed package is separated from the film webs which provide the film for the cavity and the top. This sealed package may then be subjected to an elevated temperature to cause it to shrink onto the packaged item. In such cases, it is for appearance purposes and minimizing scrap loss preferred to minimize the amount of shrinkage necessary to tightly enclose the item.

The extent of the benefit of the present invention depends upon the degree to which the portion of the cavity forming film carrying the graphics would be stretched without restricting the amount of heat transfer to this portion as well as the nature of the graphics. For typical graphics noticeable distortion may be seen at about 200% stretch and it becomes particularly noticeable at stretches of about 300% and more, though a stretch of about 400% or more is not common.

The technique of the present invention of restricting heat transfer to the portion of cavity forming film carrying graphics may provide benefit to any size package processed in accordance with U.S. Pat. Nos. 3,956,867 or 7,487,652, both of which are incorporated herein by reference. Typical cavities range in millimeters from about 150×150×25 to 600×250×150.

The cavities prepared with graphics preserved in accordance with the present invention may be used to package any item suitable for packaging in flexible film of the type compatible with the processes described in U.S. Pat. Nos. 3,956,867 or 7,487,652. It is particularly advantageous to package food items which require hermetically sealed packaging such as cheese and meat.

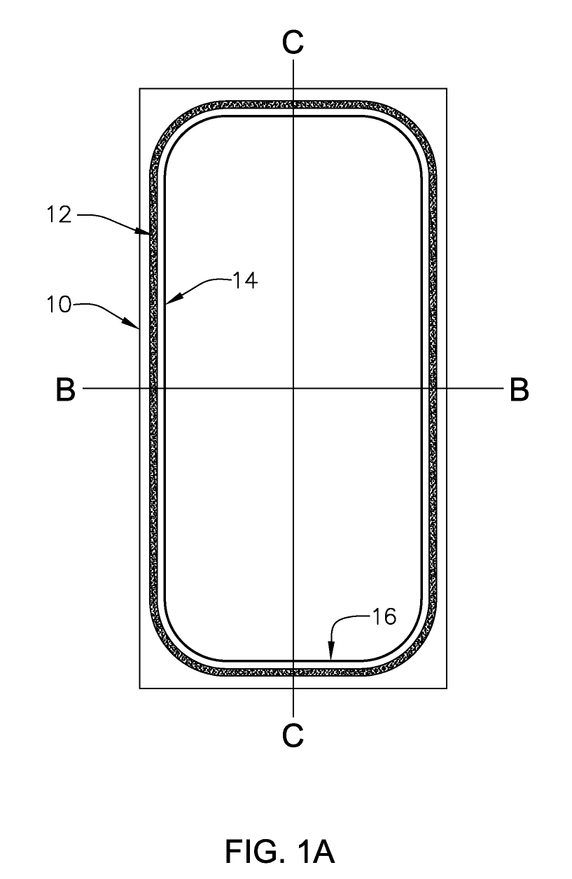

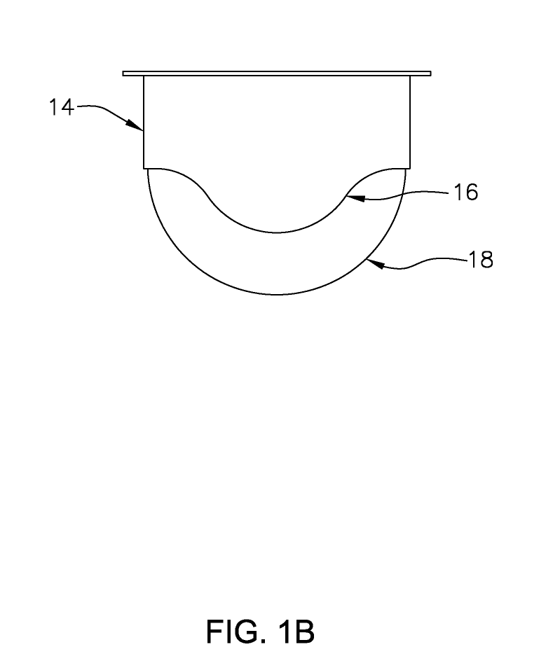

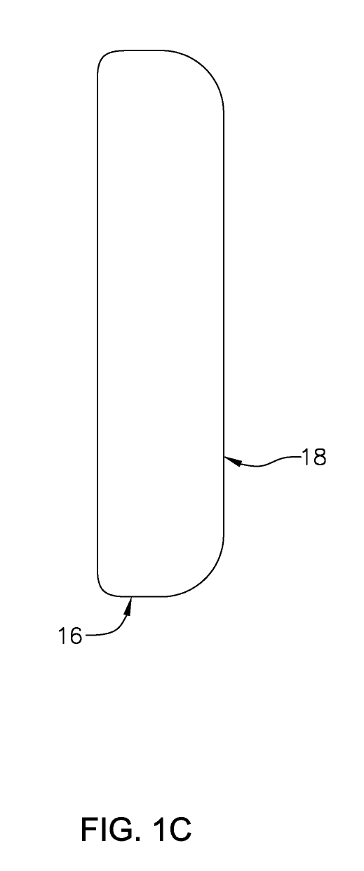

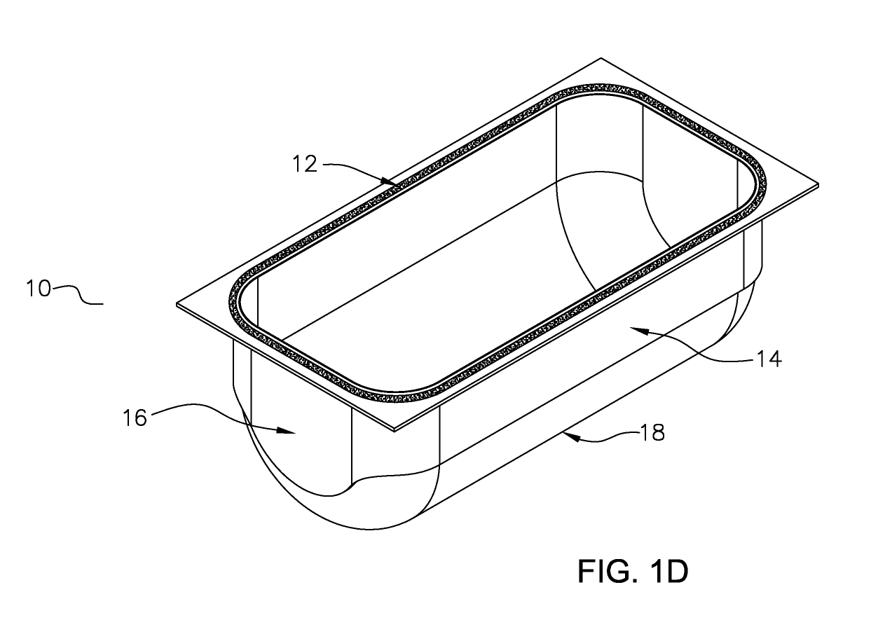

FIG. 1A through 10 illustrates the features of a mold used to form the cavity. The mold 10 has an upper edge 12 which will become the site of a heat seal between the film forming the cavity and the film sealing the mouth of the cavity and it has an inner side wall 14. It also has a rounded bottom 18 and an end wall 16. Typically film heated to a forming temperature is drawn into the mold by a vacuum supplied from beneath the mouth of the mold so that it conforms to the shape of the interior of the mold.

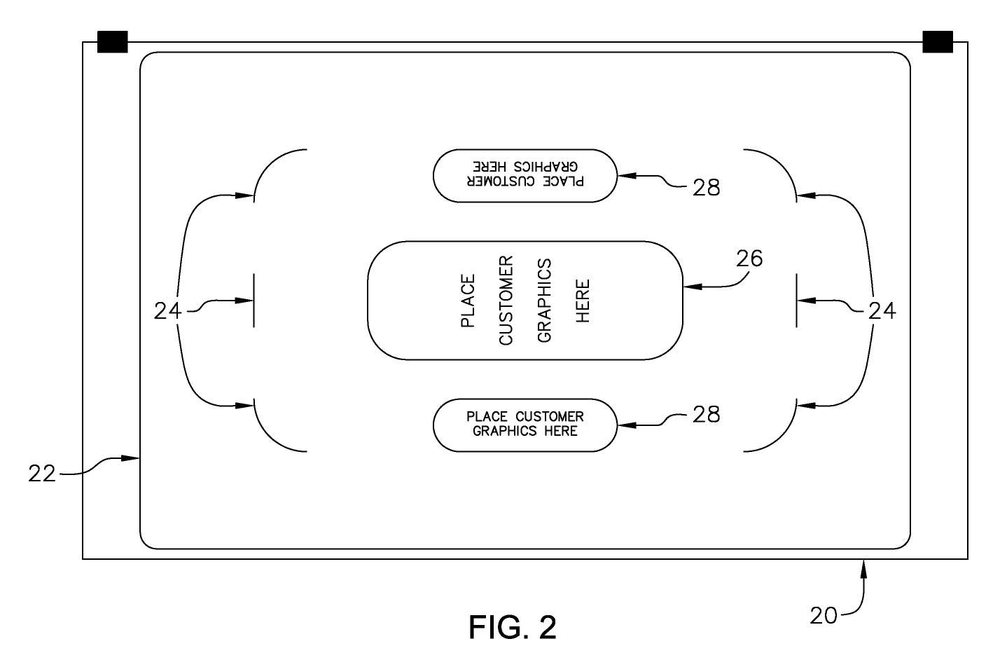

FIG. 2 illustrates a length of roll stock film 20 in position to be formed into a cavity. The forming operation will commence with this portion being drawn against a heated platen whose footprint is 22. Once the portion of the film which has contacted the heated platen 22 has reached forming temperature the vacuum applied through the heated platen will be released and a vacuum will be applied from below to draw this heated film into the mold whose partial outline is shown as 24. This length of film carries a central graphic whose outline is shown at 26 and two side graphics whose outlines are shown at 28. In the practice of the present invention heat transfer from the heated platen to these three areas would be inhibited causing these areas to see a cooler forming temperature and therefore to undergo significantly less stretching than the rest of the film which will form the cavity. If a given graphic contains solid colors, this can prevent these colors from appearing washed out, and if the graphic contains letters, this can preserve the clarity of these letters. In this regard, by limiting the heat transfer inhibition to just these three areas, substantial fully heated film is available along the long and short axes of the mold so that the formation of the cavity can occur without undue thinning of the film.

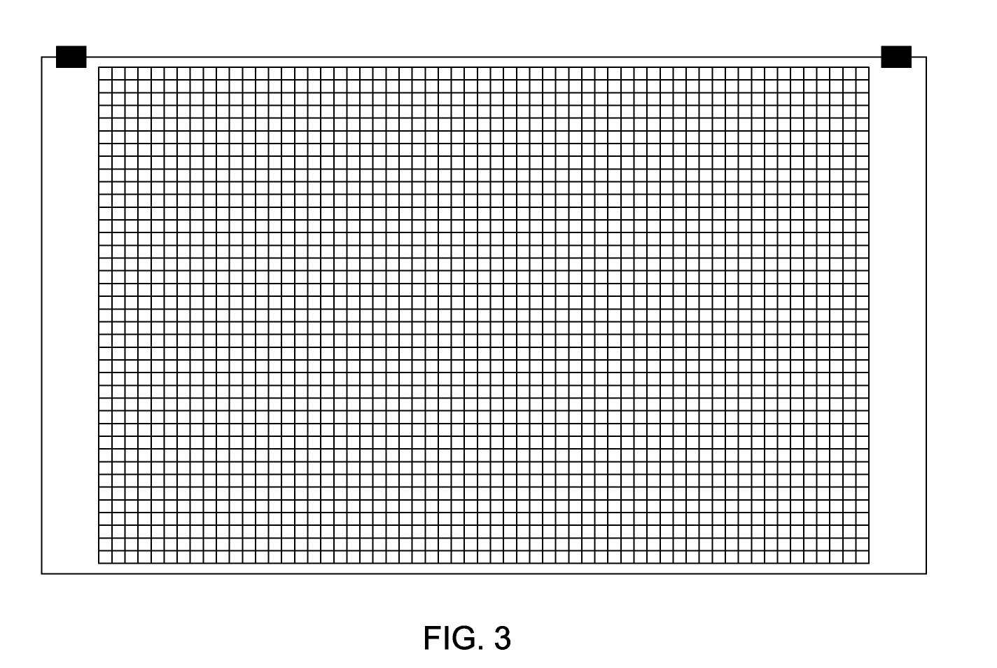

FIG. 3 illustrates a uniform testing grid used to evaluate the stretching undergone by discrete portions of the film drawn into the mold. Each of the cells will give an indication of the degree of stretch the discrete portion of the film on which it is imprinted has undergone. The grid can therefore indicate those portions which have undergone the greatest stretching and these portions can then be examined for an indication of the greatest film thinning caused by the forming operation. Reducing the formability of the film drawn into the mold to form the cavity will result in greater maximum film thinning but by carefully limiting the areas of reduced formability this additional thinning can be kept within acceptable limits.

### EXAMPLES

### Example 1

### Graphics Test Grid

A web of a heat shrinkable hot formable multilayer film suitable for the packaging of food items such as cheese and meat was used to evaluate the technique of reducing the heat transfer to a portion of the film appropriate for carrying graphics in an optimum position on a package made by the formation of a cavity, the filling of the cavity with a cheese item, the sealing of the cavity mouth with a portion of another web of a similar film and subjecting the sealed package to shrinking.

A reel of 5 mil 250 mm wide seven layer heat shrinkable film having the structure Nylon (8.45%)/adhesive layer (32.2%)/Nylon (7.2%)/Ethylene Vinyl Alcohol (8.6%)/ Nylon (7.2%)/adhesive layer (22.2%)/Mixture of Lower Density Polyethylene Based Polymers (14.2%) was prepared by a double bubble extrusion process to have a heat shrinkage at 90° C. of 40% in the machine direction and 45% in the transverse direction and imprinted in an appropriate location with a grid of inch cells.

The reel was loaded on a Multivac R555 machine which functions as outline in U.S. Pat. No. 7,487,652 and which was equipped with a 372.5 mm×240 mm heating plate which was centered above a 55 mm deep mold with a 290 mm×129 mm mouth. Both the heating plate and the mold were oriented with their long dimensions perpendicular to the transport or machine direction.

Three runs were made using essentially same conditions. The web was advanced so a portion of the film lay between the mold and the heating plate with clips holding the edges of the web and differential air pressure was used to force this portion against the heating plate which had been heated to a temperature of about 110° C. (105° C. for the first run) for about 1.5 seconds. Then a vacuum of about 12 mbar was applied to the bottom of this portion to draw it into the mold and the vacuum was maintained for between 1.5 and 3 seconds. Subsequently a 6 pound cylindrical loaf of cheese was deposited into the cavity formed by this drawing operation and the cavity was sealed using a portion of a web of a 2 mil 250 mm wide heat shrink film of the same general construction and properties as the cavity forming film using a seal temperature of 135° C. for 1 second. The sealed package was separated from the top and bottom webs using a cutting tool and then subjected to a heat shrink tunnel.

In the first run nothing was interposed between the heating plate and the cavity forming film, while in the second and third runs Teflon tape was interposed in selected areas to reduce the heat transfer between the plate and the film. In the second run a single piece of tape 6 inches long and about 5.6 inches wide was taped to the center of the heating plate such that its center corresponded to the center of the heating plate and its edges were parallel to the edges of the heating plate. In the third run three pieces of tape were used with the a center piece 6 inches long and 2.25inches wide centered the same as the single piece from the second run. The other two pieces were each 3.5 inches long and 1 inch wide, centered with regard to the length of the heating plate and off set from the center piece about 0.5 inches.

The grid was noticeably less distorted in runs 2 and 3 than in run 1. The minimum wall thickness measured in mils at the point of greatest stretch as estimated from the grid for each run was as follows:

| | | |
|---|---|---|
| Run 1 | No Tape | 0.91 |
| Run 2 | One Piece of Tape | 0.57 |
| Run 3 | Three Pieces of Tape | 0.85 |

### Example 2

### Actual Graphics

Four runs were made using procedures, conditions and materials quite similar to those used in Example 1. Two different films were used to form the cavity though both had structures essentially identical to that of the cavity forming film of Example 1. The first of these films, while 5 mils thick, had been processed in its manufacturing to be somewhat more formable. The second of these films was identical to the cavity forming film of example 1 except that it was 6 mils thick. The heating time in these four runs was 1.25 seconds and the temperature of the heating plate was 90° C. The forming time was uniformly 1.5 seconds.

The two cavity forming films were printed with actual graphics composed of images and text. The graphics were printed in the center of each film in such a way that when a given portion of the film designed to form a cavity was above the cavity mold the graphics were centered over the mouth of the mold. There was a center graphic 6 inches long and 2.25 inches wide with a smaller graphic on each side spaced about 0.5 inches from the center graphic and 3.5 inches long and 1 inch wide.

Each film was used to form a cavity using a heating plate without any tape and with Teflon tape positioned as it had been in Run 3 of Example 1. Final sealed heat shrunk packages were prepared as in Example 1.

The graphics from the runs with tape were noticeably better in color and clarity than those runs without the tape. The minimum wall thickness measured in mils at the point of greatest stretch as estimated by the experimenter based on his best judgment for each run was as follows:

| | | |
|---|---|---|
| Run 1 | 5 mil, More Formable Film, No Tape | 1.39 |
| Run 2 | 5 mi, More Formable Film, Three Pieces of Tape | 1.29 |
| Run 3 | 6 mil, As Formable as First Trial Film, No Tape | 1.62 |
| Run 4 | 6 mil, As Formable as First Trial Film, Three | 1.41 |
| | Pieces of Tape | |

The above disclosure is for the purpose of illustrating the present invention and should not be interpreted as limiting the present invention to the particular embodiment s described but rather the scope of the present invention should only be limited by the claims which follow and should include those modifications of what is described which would be readily apparent to one skilled in the art.

What is claimed is:

1. In a process of forming a cavity for the packaging of a food item by heating a flexible plastic film carrying graphics intended to serve as a label for the packaged food and stretching it at a temperature which renders the film sufficiently stretchable to form the cavity, the improvement comprising heating said film to its stretching temperature with a platen with a cooler zone in registry with said graphics whereby the portion of the film carrying said graphics is subjected to significantly less stretching than the rest of said film in the formation of said cavity.

2. The improvement of claim 1 wherein the platen has two cooler zones of different temperatures with the warmer one completely surrounding the perimeter of the one in registry with said graphics to provide a transition zone in the film between the portion of the cavity forming film experiencing the greatest stretching and the portion carrying said graphics.

3. The improvement of claim 1 wherein there is a substantial margin between all the edges of the portion of the film forming said cavity and the portion of said film carrying said graphics and the cooler zone in registry with said graphics lies entirely inside said margin.

4. The improvement of claim 3 wherein said graphics is on a surface of said film which is not adjacent to any of the edges of said cavity forming film.

5. In a process for the packaging of an item in a heat formable polymer film carrying graphics by heating the film to a forming temperature and drawing it into a die to form a cavity into which the item is deposited, the improvement in which the heating of the portion of the film carrying the graphics is restrained such that it stretches substantially less than the rest of the film forming said cavity and said portion constitutes substantially less than all of the film drawn into said die in any direction.

6. In a process for the packaging of an item in a heat formable polymer film carrying graphics by providing the film as a continuous web such that the edges parallel to the direction of transport are restrained from movement perpendicular to the direction of transport, transporting a portion of the film over a die cavity adapted to form a cavity in said portion to accommodate said item, heating said portion including a substantial margin surrounding the mouth of said cavity to a forming temperature and drawing it into a die to form a cavity into which the item is deposited, the improvement wherein the heating of the area or areas of the film carrying the graphics is restrained such that it stretches substantially less than the rest of the film forming said cavity and the total extension of said area or areas in both in the transport direction and perpendicular to the transport direction is substantially less than the total extension of the heated film in that direction.

7. The improvement of claim 6 wherein the heating of said portion is affected by forcing it into contact with a heated plate and the heated plate is configured to have an area or areas of a cooler temperature which overlies said graphics.

8. The improvement of claim 7 wherein said cooler area or areas of said plate cause the film forced into contact with them to be at least about 10° C. cooler than the bulk of the film forced into contact with said heating plate.

9. The improvement of claim 6 wherein said total extension of the area or areas of restrained heating in each of said directions is about 60% or less of the total length of heated film in that direction.

10. The improvement of claim 9 wherein said total extension is about 40% or less of the total length of heated film in that direction.

11. The improvement of claim 6 wherein the said cavity forming film has a thickness between about 3 and 8 mils.

12. The improvement of claim 11 wherein the cavity forming film is a multilayer polymeric film with an outer layer designed to preserve package integrity, a core layer designed to provide a gas transmission barrier and an inner layer designed to provide heat sealability.

13. The improvement of claim 12 wherein the outer layer is a polyester or a polyamide, the core layer is a ethylene vinyl alcohol copolymer or a ployvinylidene chloride and the inner layer is a low melting point polyolefin.

14. The improvement of claim 6 wherein the cavity forming film is a heat shrinkable film.

15. The improvement of claim 14 wherein the after said cavity is formed and said item is deposited into said cavity, the mouth of said cavity is closed by heat sealing another film across said mouth and the sealed package so formed is subjected to an elevated temperature to cause said heat shrinkable film to shrink.

16. The improvement of claim 15 wherein the dimensions of said cavity and said item are such that said heat shrinking results in a reduction in the dimensions of said sealed package of no more than 10%.

17. The improvement of claim 6 wherein said item deposited in said cavity is an item of food.

18. The improvement of claim 17 wherein said food item is meat or cheese.

19. The improvement of claim 17 wherein said cavity forming film is a multilayer polymeric film wherein the outer layer is a polyester or a polyamide, the core layer is an ethylene vinyl alcohol copolymer or a ployvinylidene chloride and the inner layer is a low melting point polyolefin.

20. The improvement of claim 6 wherein more than one area of said cavity forming film carries graphics and there are portions of said cavity forming film between said areas to which the transfer of heat is not restrained.
